(19) United States
(12) Patent Application Publication
(10) Pub. No.: US 2023/0038947 A1
(43) Pub. Date: Feb. 9, 2023

(54) SYSTEMS AND METHODS FOR VEHICLE LIFECYCLE MANAGEMENT USING ONBOARD DATA CAPTURE DEVICES

(71) Applicant: JPMORGAN CHASE BANK, N.A., New York, NY (US)

(72) Inventor: Rick F. PINTO, Trabuco Canyon, CA (US)

(21) Appl. No.: 17/817,590

(22) Filed: Aug. 4, 2022

Related U.S. Application Data
(60) Provisional application No. 63/229,822, filed on Aug. 5, 2021.
(60) Provisional application No. 63/362,941, filed on Apr. 13, 2022.

(51) Int. Cl. G06Q 30/06; G06Q 30/02; G07C 5/08

(52) U.S. Cl. CPC G06Q 30/0645; G06Q 30/0206; G07C 5/0808; G07C 5/0816

(57) ABSTRACT

Systems and methods for vehicle lifecycle management using onboard vehicle onboard data capture devices are disclosed. In one embodiment, a method of vehicle lifecycle management may include: enrolling, by a vehicle lifecycle computer program executed by an electronic device, a vehicle in a vehicle lifecycle management service; receiving, by the vehicle lifecycle computer program, a request to initiate a vehicle lifecycle event; enabling, by the vehicle lifecycle computer program, a telematics unit in the vehicle; receiving, by the vehicle lifecycle computer program, vehicle attributes from the telematics unit; requesting, by the vehicle lifecycle computer program, vehicle condition data from an on-board vehicle management computer program; receiving, by vehicle lifecycle computer program, the vehicle condition data from the on-board vehicle management computer program; receiving, by the vehicle lifecycle computer program, a request to terminate the vehicle lifecycle event; and disabling, by the vehicle lifecycle computer program, the telematics unit.

### RELATED APPLICATIONS

This application claims priority to, and the benefit of, U.S. Provisional Pat. Application Ser. No. 63/229,822, filed Aug. 5, 2021 and U.S. Provisional Pat. Application Ser. No. 63/362,941, filed Apr. 13, 2022, the disclosure of which are hereby incorporated, by reference, in their entireties.

### BACKGROUND OF THE INVENTION

### 1. Field of the Invention

The present disclosure generally relates to systems and methods for vehicle lifecycle management using onboard data capture devices.

### 2. Description of the Related Art

Vehicle leasing companies struggle to obtain accurate and timely information in a secure manner when a customer returns a leased vehicle. This leads to delays in lease-end processing and frustration for the lease customer. This pain-point contributes to additional depreciation of the collateral and added cost to the disposal of the lease units. On average, vehicles depreciate every day (the amount depends on the vehicle segment), and the average life cycle to dispose of a unit is 7-60 days depending on where the vehicle is sold. Additional delays are incurred as a result of vehicles being manually inspected to capture condition and mileage.

### SUMMARY OF THE INVENTION

Systems and methods for vehicle lifecycle management using onboard vehicle onboard data capture devices are disclosed. In one embodiment, a method of vehicle lifecycle management may include: (1) enrolling, by a vehicle lifecycle computer program executed by an electronic device, a vehicle in a vehicle lifecycle management service; (2) receiving, by the vehicle lifecycle computer program, a request to initiate a vehicle lifecycle event; (3) enabling, by the vehicle lifecycle computer program, a telematics unit in the vehicle; (4) receiving, by the vehicle lifecycle computer program, vehicle attributes from the telematics unit; (5) requesting, by the vehicle lifecycle computer program, vehicle condition data from an on-board vehicle management computer program; (6) receiving, by vehicle lifecycle computer program, the vehicle condition data from the on-board vehicle management computer program; (7) receiving, by the vehicle lifecycle computer program, a request to terminate the vehicle lifecycle event; and (8) disabling, by the vehicle lifecycle computer program, the telematics unit.

In one embodiment, the vehicle attributes may include a vehicle location, a vehicle odometer reading, a fault code, etc.

In one embodiment, the vehicle condition data may include vehicle image data and/or sensed vehicle data.

In one embodiment, the vehicle image data comprises a plurality of images of the vehicle captured by vehicle image capture devices that indicate a current condition of the vehicle. The sensed vehicle data may include identifiers associated with installed equipment on the vehicle. The installed equipment may include vehicle electronics and vehicle body parts. The identifiers may be associated with radio frequency tags, Bluetooth Low Energy tags, and/or Quick Response codes.

In one embodiment, the method may also include assessing, by the vehicle lifecycle computer program, a current vehicle condition based on the vehicle attributes by identifying differences between the vehicle condition data and stored vehicle condition data. In one embodiment, the stored vehicle condition data may be received at a prior vehicle lifecycle event.

In one embodiment, the method may also include assessing, by the vehicle lifecycle computer program, a cost for the identified differences.

According to another embodiment, an electronic device may include a computer processor and a memory storing a vehicle lifecycle computer program. When executed by the computer processor, the vehicle lifecycle computer program causes the computer processor to: receive vehicle attributes from a telematics unit in a vehicle; receive vehicle condition data from an on-board vehicle management computer program in the vehicle; retrieve stored vehicle condition data for the vehicle; identifying differences between the vehicle condition data and the stored vehicle condition data; determining that the differences are not acceptable differences; assessing a cost associated with the differences; and communicating the differences and the cost to a vehicle owner.

In one embodiment, the vehicle attributes may include one or more of a vehicle location, a vehicle odometer reading, and a fault code.

In one embodiment, the vehicle condition data may include vehicle image data and/or sensed vehicle data. The vehicle image data may include a plurality of images of the vehicle captured by vehicle image capture devices that indicate a current condition of the vehicle. The sensed vehicle data may include identifiers associated with installed equipment on the vehicle. The installed equipment may include vehicle electronics and vehicle body parts. The identifiers may be associated with radio frequency tags, Bluetooth Low Energy tags, and/or Quick Response codes.

According to another embodiment, a system may include a vehicle lifecycle server comprising a vehicle lifecycle server computer processor and executing a vehicle lifecycle computer program and vehicle comprising vehicle computer processor executing an onboard vehicle management computer program, a telematics unit, a plurality of image capture devices, and a sensor that senses a presence or absence of vehicle equipment. The telematics unit may retrieve vehicle attributes from vehicle systems. The vehicle lifecycle computer program may receive the vehicle attributes from the telematics unit. The onboard vehicle management computer program may receive vehicle condition data from the sensor. The vehicle lifecycle computer program may receive the vehicle condition data from the onboard vehicle management computer program. The vehicle lifecycle computer program may retrieve stored vehicle condition data for the vehicle. The vehicle lifecycle computer program may identify differences between the vehicle condition data and the stored vehicle condition data. The vehicle lifecycle computer program may determine that the differences are not acceptable differences. The vehicle lifecycle computer program may assess a cost associated with the differences. The vehicle lifecycle computer program may communicate the differences and the associated cost to a vehicle owner.

In one embodiment, the vehicle attributes comprise one or more of a vehicle location, a vehicle odometer reading, and a fault code.

In one embodiment, the vehicle condition data may include vehicle image data and/or sensed vehicle data, wherein the vehicle image data may include a plurality of images of the vehicle captured by vehicle image capture devices that indicate a current condition of the vehicle and the sensed vehicle data may include identifiers associated with installed equipment on the vehicle, wherein the identifiers may be associated with radio frequency tags, Bluetooth Low Energy tags, and/or Quick Response codes.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for vehicle lifecycle management according to an embodiment of the present disclosure.

FIG. 2 depicts a method for vehicle lifecycle management according to an embodiment of the present disclosure.

FIG. 3 depicts a method for remote capture of vehicle condition data according to an embodiment of the present disclosure.

FIG. 4 depicts an exemplary image capture routine according to an embodiment of the present disclosure.

FIG. 5 depicts an example of a computing system for implementing certain aspects of the present disclosure.

### DETAILED DESCRIPTION

Embodiments are directed to systems and methods for vehicle lifecycle management, according to aspects of the present disclosure. For instance, a vehicle lifecycle management system may be configured to activate, initiate one or more lifecycle processes, and monitor a vehicle during the lifecycle process.

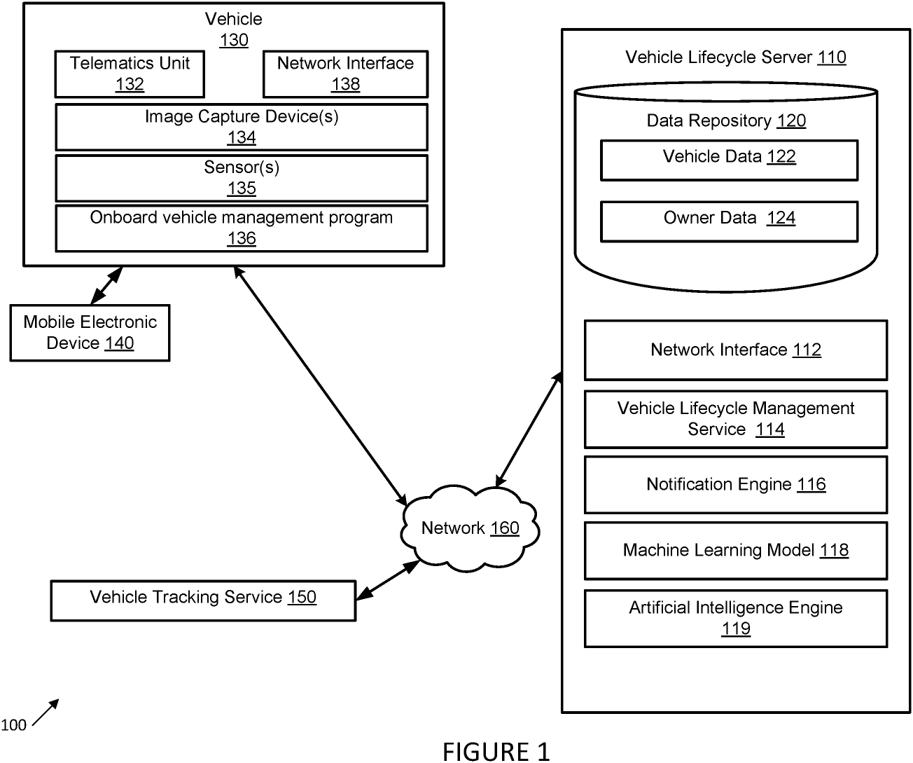

FIG. 1 depicts a system for vehicle lifecycle management according to embodiments of the present disclosure. System 100 may include vehicle lifecycle server 110, one or more vehicles 130, vehicle tracking service 150, and network 160. Vehicle lifecycle server 110 may be any suitable server, including, for example, physical servers and cloud-based servers. Vehicle lifecycle server 110 may be communicatively coupled to one or more vehicles 130 and vehicle tracking service 150. Vehicle lifecycle server 110 may include network interface 112, vehicle lifecycle management service 114, notification engine 116, machine learning model 118, and artificial intelligence engine 119. Vehicle lifecycle management service 114 may be a computer program that is executed by vehicle lifecycle server 110, or it may be configured as a distributed application that may be executed by vehicle lifecycle server 110.

Vehicle lifecycle server 110 may also include data repository 120, which may store vehicle data 122, owner data 124, etc. In one example, data repository 120 may include a database, a structured data store, cloud storage, etc.

Vehicle 130 may be a car, a plane, a boat, a recreational vehicle, a personal watercraft, a motorcycle, and the like. Vehicle 130 may include telematics unit 132 and network interface 138 that may provide an interface for recording attributes of vehicle 130 and transmitting a selection of the attributes to vehicle lifecycle server 110. Vehicle 130 may also receive notifications from vehicle lifecycle server 110, for example, an initiation of a vehicle lifecycle event, a status change for a vehicle lifecycle event, a termination of a vehicle lifecycle event, etc.

Vehicle 130 may also include one or more image capture devices 134, which may be a camera or similar device. Image capture device 134 may be integrated into vehicle 130, may be part of mobile electronic device 140, or may be a separate device. Image capture device 134 may capture images or video of the interior of vehicle 130, the exterior of vehicle 130, the engine compartment of vehicle 130, the underside of vehicle 130, etc.

Image capture device 134 may include front-facing cameras, backup cameras, side-view cameras, corner-mounted cameras, internal cameras, etc. For example, cameras may be mounted internally on the rear-view mirror, headrests, externally on the body of vehicle 130, etc. The image capture device 134 may be mounted in a fixed position, or may be mounted to swivel or articulate.

Vehicle 130 may include one or more sensors 135 that may be installed on vehicle 130 or parts of vehicle 130. Examples of sensors 135 may include impact detection devices, sensors associated with vehicle parts (e.g., radio frequency (“RF”) or Bluetooth Low Energy (“BLE”) tags embedded in body panels, electrical or mechanical components, Quick Response (“QR”) codes embossed or affixed to body panels, electrical or mechanical components, etc.), etc. Sensors 135 may be used to detect damage, part replacement, etc. that may identify any variances in the condition of vehicle 130 that may impact its resale value.

Vehicle 130 may include onboard vehicle management program 136 that may control the operation of equipment on vehicle 130. Onboard vehicle management program 136 may interact with or control the operation of image capture devices 134 and sensors 135. For example, onboard vehicle management program 136 may control one or more image capture device 134 to execute one or more image capture routines that are configured to utilize a vehicle’s onboard cameras to capture images of vehicle 130. The image capture routines may be initialized by vehicle lifecycle server 110 upon a receipt of, or a request to initiate, a grounding event, or other vehicle lifecycle event from the vehicle.

Onboard vehicle management program 136 may also interact with one or more sensors 135 to identify replacement or removal, damage, etc. to vehicle equipment.

Vehicle 130 may further include a processing unit (not shown), which may include electronic storage and a processor, such as a computer processor, for storing and/or carrying out programmatic instructions.

Vehicle lifecycle server 110 may be configured to receive information from network interface 138 and vehicle tracking service 150. For example, vehicle lifecycle server 110 may receive telematics data from telematics unit 132 and vehicle tracking data from vehicle tracking service 150. Vehicle lifecycle server 110 may store the data received from telematics unit 132 and vehicle tracking service 150 in data repository 120.

Vehicle lifecycle server 110 may classify the received data, such as determining that a particular stream of received data relates to diagnostic trouble codes (“DTCs”), vehicle condition, vehicle value, vehicle ownership information, or vehicle current location, or last known location information. Vehicle lifecycle server 110 may store the received telematics data and location (current or last known) information in vehicle data 122, may store vehicle ownership information in owner data 124, etc. Vehicle data 122 and/or owner data 124 may be protected or encrypted as appropriate for compliance with the applicable local rules, regulations, or security/privacy policies.

In one embodiment, vehicle lifecycle server 110 may store vehicle data 122 and/or the owner data 124 in a data repository 120 that is distributed across a plurality of network devices, such as a public or private blockchain ledger. Vehicle lifecycle server 110 may determine, based on a classification of the received data, one or more distributed ledgers to store vehicle data 122 and/or owner data 124.

For example, vehicle data 122 may include vehicle make, model, mileage (e.g., an odometer reading), year, condition, and system functions. In one embodiment, vehicle data may include information on installed equipment and any identifiers therefore (e.g., a head unit identifier, body panel sensor identifiers, etc.), vehicle damage reports, etc. Telematics unit 132 may record vehicle speed, braking, system warning codes, DTCs or fault indications and communicate a portion or all of these values to the vehicle lifecycle server 110 via network interface 138.

Owner data 124 may include title data, lien information, a primary driver indication, and additional driver information. Each vehicle 130 may be communicatively coupled to one or more mobile electronic devices 140. Mobile electronic device 140 may authenticate a particular user of mobile electronic device 140. Mobile electronic device 140 may communicate, via an application executed by mobile electronic device 140, ownership information, insurance information, etc., to network interface 138 and further to vehicle lifecycle server 110 via network 160.

Vehicle lifecycle management service 114 may be a software application or program executed by vehicle lifecycle server 110. Vehicle lifecycle management service 114 may determine that a vehicle lifecycle event is initiated based on vehicle data 122 or owner data 124 that may be received from vehicle 130. Vehicle lifecycle management service 114 may receive an indication that telematics unit 132 has requested to activate a tracking feature for vehicle 130 and/or requested a service from vehicle tracking service 150. Vehicle lifecycle management service 114 may determine based on the location, mileage (e.g., odometer reading), and/or an authenticated driver of vehicle 130 that a “grounding event” has occurred and initiates a vehicle lifecycle event corresponding to the event. In this example, the grounding event may indicate that the authenticated driver is returning vehicle 130 from a leasing agency.

In embodiments, the identification of the grounding event and information from the vehicle may be used to initiate downstream operational processes, including closing the lease, preparing a title for the vehicle so it can be sold in a secondary market, notifying potential buyers of the vehicle will be coming up for sale, etc.

Vehicle lifecycle management service 114 may notify the owner or lessor of vehicle 130 that vehicle 130 has initiated a grounding event. Vehicle lifecycle management service 114 may provide the vehicle owner or lessor with the location of vehicle 130 and may perform a Personal Identifiable Information (“PII”) wipe of the lessee information on vehicle 130 (e.g., delete address book, connected devices, calendars, GPS breadcrumbs like prior destinations, etc.), etc. It may also provide the vehicle owner or lessor with the mileage of and any DTCs from vehicle 130.

As another example, vehicle lifecycle management service 114 may determine, based on the location, mileage, and/or other attributes of vehicle 130, that a “shipping event” has occurred, and may initiate a vehicle lifecycle event corresponding to the shipping event. The shipping event may indicate that vehicle 130 has been completed at a manufacturing location and is being transported to a purchaser location. Vehicle lifecycle management service 114 may notify the manufacturer, financing source (e.g., the floorplan lender), the purchaser, or an intermediary (e.g., a dealer) that the shipping event has occurred. Vehicle lifecycle management service 114 may provide the location of vehicle 130, to include updating the location if movement of the vehicle 130 is detected, to the manufacturer, purchaser, or the intermediary.

Notification engine 116 may be executed as an integrated part of vehicle lifecycle management service 114, as a separate software application, or electronic transmission. Notification engine 116 may provide notifications such as push notifications, messages, or other types of alerts to indicate that a vehicle lifecycle event has occurred. In some embodiments, notification engine 116 may provide individualized preferences for notifications for the owner, purchaser, intermediary, and the like.

Machine learning model 118 may receive, as input, vehicle data 122, owner data 124, or other data. Machine learning model 118 may generate a prediction of one or more attributes relating to a vehicle lifecycle event such as an arrival time, a condition, an estimated event timing, and the like. Machine learning model 118 may further predict that vehicle 130 may have a specific sequence of vehicle lifecycle events based on the make, model, year, location, DTCs, and drivers. For instance, if a particular type of vehicle (e.g., based on a cluster or other prediction of similar vehicles) is likely to have a particular type of damage at a specific location and mileage, machine learning model 118 may notify the owner, manufacturer, purchaser, or the like.

Artificial intelligence engine 119 may identify any differences in the condition of vehicle 130. For example, artificial intelligence engine 119 may receive both past and current data from image capture device(s) 134 and/or sensor(s) 135, and may identify any changes. For example, artificial intelligence engine 119 compare past and current images to identify any changes in condition or replaced equipment (e.g., a tear in a seat, replaced tires, replaced head unit, etc.). Artificial intelligence engine 119 may also compare sensed data to identify replaced or added equipment (e.g., a missing sensor code for a body panel, a replaced non-OEM alternator, etc.). Artificial intelligence engine 119 may then apply a policy from the owner or lessor of vehicle 130 to determine whether the lessee should be responsible for the change in condition (e.g., no charge if a dent is smaller than the size of a credit card), and may access one or more public or private databases (not shown) to determine a cost to return vehicle 130 to its prior condition.

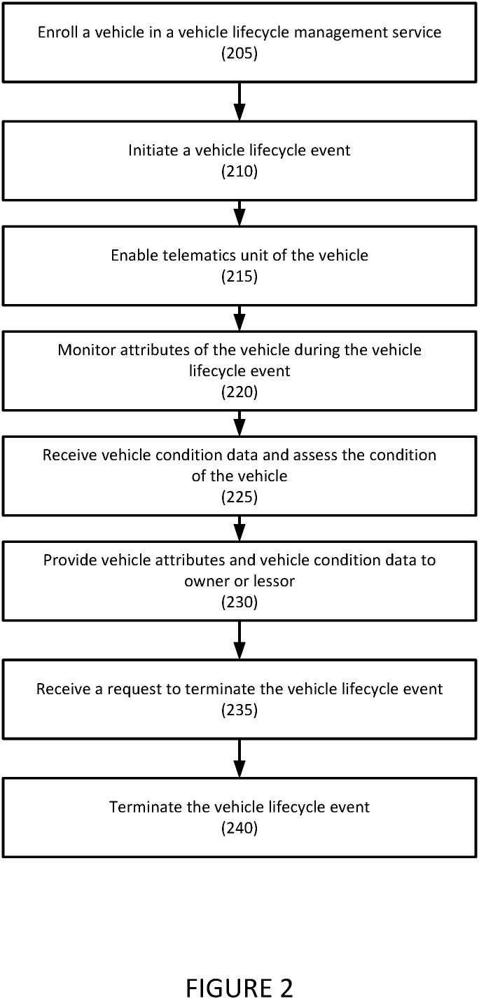

FIG. 2 depicts a method for vehicle lifecycle management according to one embodiment.

In step 205, a computer program, such as a vehicle lifecycle management service computer program, may enroll a vehicle in a vehicle lifecycle management service. In one example, a vehicle manager computer program may enroll a vehicle into a vehicle lifecycle manager by receiving an identifier of the vehicle such as a VIN, hardware identifier, transaction number, or the like.

In step 210, the computer program may initiate a vehicle lifecycle event. In one example, the vehicle manager program may initiate one or more vehicle lifecycle events such as a “shipped from manufacturer,” or “insurance event,” or “vehicle lease termination” (e.g., grounding), etc.

In step 215, the computer program may enable a telematics unit of the vehicle. In response to the initiation of a vehicle lifecycle event, the vehicle may enable the telematics unit to include GPS location monitoring and the like.

In step 220, the computer program may monitor vehicle attributes from the telematics unit of the vehicle during the vehicle lifecycle event. The vehicle manager program may monitor a location, a mileage (e.g., an odometer reading), various fault codes, and the like. For example, the vehicle manager computer program may provide notifications for predefined conditions such as a significant mileage increase, a category of fault code, DTCs, or the like to an owner, a mobile device associated with the vehicle or an intermediary.

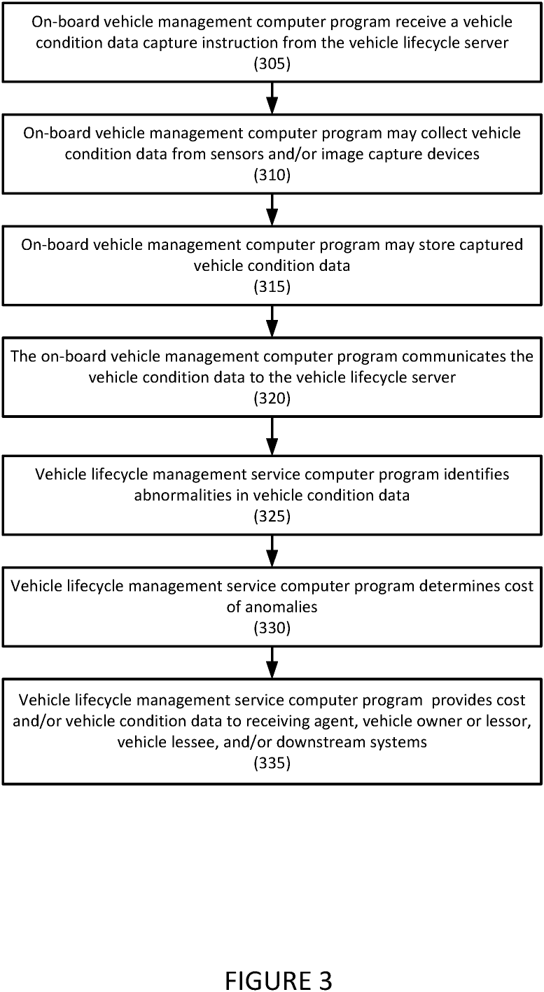

In step 225, the computer program may optionally capture vehicle condition data for the vehicle and may assess the condition of the vehicle. An example of such a process is provided in FIG. 3.

In one embodiment, the computer program may perform a PII wipe of the lessee information that may be stored on the vehicle by, for example, deleting address book information, connected device information, calendar information, GPS breadcrumbs like prior destinations, etc. from the vehicle memory.

In step 230, the computer program may provide the vehicle attributes and/or vehicle condition data to the vehicle owner or lessor for pricing, to prepare for selling or leasing the vehicle, etc. For example, the vehicle attributes and/or condition data may be used to set the price for the vehicle. In one embodiment, market conditions, such as local inventory, may be considered in setting the vehicle price.

The computer program may also provide information that may be helpful in identifying the best location for selling or leasing the vehicle. For example, the computer program may compare, in real-time, the current location to a location where vehicles with similar mileage, color, and condition are receiving the highest prices. This facilitates a business decision as to how to price the vehicle, and/or whether the vehicle should be moved to a different location, to achieve the highest percentage of the manufacturer suggested retail price.

In step 235, the computer program may receive a request to terminate the vehicle lifecycle event. The vehicle manager computer program may receive a request, such as from the owner, dealer, or intermediary, that indicates that the vehicle lifecycle event may be terminated. Examples of terminations may include a change of ownership, an insurance total declaration, or arrival of the vehicle at a location of interest.

In step 240, the computer program may terminate the vehicle lifecycle event. In response to request for termination of the vehicle lifecycle event, the computer program may terminate the vehicle lifecycle event. In some embodiments, the termination of a lifecycle event may also involve disconnecting or restricting communications with the telematics unit of the vehicle.

Referring to FIG. 3, a method for remote capture of vehicle condition data according to embodiments. The method may be performed as part of a response to a vehicle lifecycle event for a vehicle.

As part of the vehicle lifecycle event, the vehicle lifecycle server may send instructions to the vehicle to capture vehicle condition data. For example, the instructions may capture vehicle images using one or more image capture routines and/or data from one or more sensors. The vehicle condition data may be used to identify changes in the condition of the vehicle from a prior state (e.g., vehicle condition data captured at the beginning of the lease).

In one embodiment, the vehicle lifecycle server may provide instructions to execute the data capture, such as complete instructions for the image capture routine and/or the sensor capture routine. In another embodiment, the instructions from the vehicle lifecycle server may include an initiation instruction, and the rest of the instructions for carrying out the image capture routine and/or the sensor capture routine may be stored at the vehicle (e.g., at a processing unit of the vehicle). In another embodiment, the instructions may include an initiation and a portion of the instructions for the image capture routine and/or the sensor capture routine, while the remaining portion of the instructions may be stored at the vehicle.

In one embodiment, vehicle condition data may be captured from one or more sensors in the vehicle, including equipment identifiers (e.g., RF or BLE tags, QR codes, etc.).

At step 305, an on-board vehicle management computer program may receive a vehicle data collection instruction, which may include an image capture instruction and a sensor instruction, from a vehicle lifecycle server.

In step 310, the on-board vehicle management computer program may control one or more image capture devices to execute an image capture routine to capture some or all of the interior and/or the exterior of the vehicle. In one embodiment, the image capture routine may be received with the initiation instruction, including identification of damage or non-original equipment.

In one embodiment, the on-board vehicle management computer program may modify the image capture routine based on the images captured by the image capture devices.

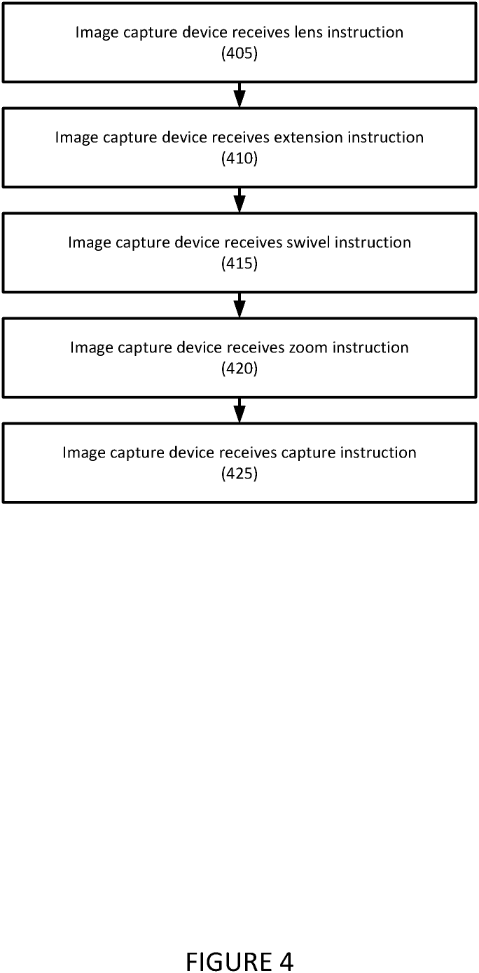

An example of an image capture routine is provided in FIG. 4.

The on-board vehicle management computer program may capture vehicle information using one or more sensors. For example, one or more sensors may detect equipment identifiers, such as RF or BLE tags, QR codes, etc., on vehicle equipment (e.g., body panels, electrical or mechanical equipment, etc.).

In step 315, the on-board vehicle management computer program may store the images and/or sensed data in a local memory. The memory may be volatile, non-volatile, or the routine may store the images and/or sensed data in both volatile and non-volatile memory.

In step 320, the on-board vehicle management computer program may communicate the images and/or sensed data to the vehicle lifecycle server. Once received at the vehicle lifecycle server, in step 325, the images and/or sensed data may be made available to interested parties, such as the leasing organization.

In step 325, the vehicle lifecycle management service computer program may identify abnormalities in vehicle condition data. In one embodiment, an artificial intelligence engine may compare the current vehicle condition data to a prior vehicle condition data. For example, the artificial intelligence engine may compare the past and current images to identify any changes in condition or replaced equipment (e.g., a tear in a seat, replaced tires, replaced head unit, etc.). The artificial intelligence engine may also compare sensed data to identify replaced or added equipment (e.g., a missing sensor code for a body panel, a replaced non-OEM alternator, etc.).

In one embodiment, the artificial intelligence engine may annotate the images or sensor data to identify the differences.

In one embodiment, the artificial intelligence engine may also compare the current images to OEM images of the vehicle to identify any mismatches. The OEM images may be of the specific vehicle, or of a representative vehicle (e.g., same model, build, etc.).

In step 330, the vehicle lifecycle management service computer program may determine a cost of one or more of the anomalies. In one embodiment, the artificial intelligence engine may apply a policy from the owner or lessor of the vehicle to determine whether the lessee should be responsible for the change in condition (e.g., no charge if a dent is smaller than the size of a credit card), and may access one or more public or private databases (not shown) to determine a cost to return the vehicle to an acceptable condition, which may include acceptable wear-and-tear from the prior state.

In step 335, the vehicle lifecycle management service computer program may provide the cost and/or vehicle condition data to a receiving agent, the owner or lessor, the lessee, and any downstream systems. In one embodiment, the cost and/or vehicle condition data may be provided at the conclusion of the vehicle condition capture routine. The cost and/or vehicle condition data may be stored, written to a blockchain-based ledger, etc.

FIG. 4 depicts an image capture routine according to an embodiment. In step 405, an onboard image capture device may receive a lens instruction. The lens instruction indicates an appropriate lens for use during the image capture routine. The onboard image capture device may initiate a lens change operation based on the lens instruction if the appropriate lens is not already in place at the onboard image capture device.

In step 410, the onboard image capture device may receive an extension instruction. The extension instruction may include instructions to extend a mechanical arm or other mechanical linkage on which the onboard vehicle camera is mounted.

In step 415, the onboard image capture device may receive a swivel instruction. The swivel instruction may include one or more rotation angles in one or several planes of rotation for which the mechanical mounting of the onboard vehicle camera allows rotation of the camera. The swivel instructions can include any instructions for setting the camera in any predetermined orientation for capturing desired images during the image capture routine.

In step 420, the onboard image capture device may receive a zoom instruction. The zoom instruction can instruct the camera to zoom in or out, using either a mechanical or programmatic zoom function of the image capture device, to a predetermined zoom setting. The predetermined zoom setting may be selected on the basis of the detail of the vehicle features that the zoom setting provides in a corresponding image captured at the zoom setting.

In step 425, the onboard image capture device may receive a capture instruction that instructs the camera to capture an image. The image will be captured with the lens indicated in the lens instruction, at the angle and orientation specified by the combination of the extension instruction and swivel instruction, and at the zoom setting specified in the instruction.

In accordance with embodiments, the sequence of steps/instructions may be sent to the onboard image capture device multiple times, and each sequence may have different values for all or some of the respective settings. For instance, the sequence may be sent several times, each with a different extension and/or swivel instruction, such that when the image capture device receives the capture instruction, an image from a different perspective may be captured than one captured at an earlier (or later) capture instruction.

In accordance with embodiments, if an onboard image capture device receives instructions for a function that is absent from the onboard image capture device (e.g., the onboard image capture device is fixed and cannot execute an extension or a swivel instruction), then the onboard image capture device may ignore the instructions. In other embodiments, the vehicle processing unit can be configured to send custom instructions to one or more onboard image capture device which do not include instructions that the image capture device is not capable of executing.

In accordance with embodiments, a vehicle and the vehicle’s onboard image capture device may also receive instructions from a user device (e.g., mobile electronic device 140). The user device may be pre-authenticated with the vehicle, as described above. The user device may send/initiate a predetermined set of instructions to the vehicle and may receive one or more images back from the onboard image capture device as a result of the instructions. In some embodiments, the user device can send instructions including a series of rapid capture events (i.e., a video), and receive the video at the mobile device. In some embodiments, the user may send an instruction including custom extension and swivel instructions, such that the image capture device may be moved while recording images or videos. Through the use of such user-initiated instructions, the user of the mobile device can see the vehicle and/or the area surrounding the vehicle in real-time. This can enhance security and safety.

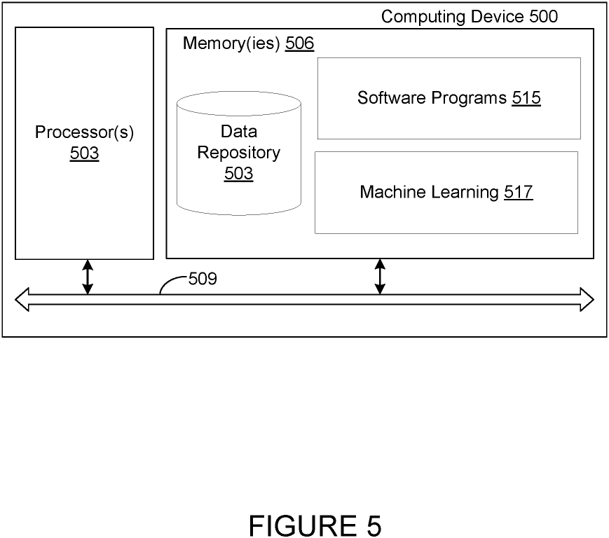

FIG. 5 depicts an example of a computing system for implementing certain aspects of the present disclosure. Example of computing device 500 includes processor 503 coupled to a memory 506. Processor 503 executes computer-executable program code stored in memory 506, such as software programs 515 or machine learning 517. Processor 503 and memory 506 may be coupled by bus 509. In some examples, bus 509 may also be coupled to one or more network interface devices (not shown). In the case of an image capture device, computing device 500 may include elements such as one or more lenses, a shutter, a charge-coupled device (“CCD”) or a c CMOS (“CMOS”) image sensor, etc.

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method of vehicle lifecycle management comprising:
enrolling, by a vehicle lifecycle computer program executed by an electronic device, a vehicle in a vehicle lifecycle management service;
receiving, by the vehicle lifecycle computer program, a request to initiate a vehicle lifecycle event;
enabling, by the vehicle lifecycle computer program, a telematics unit in the vehicle;
receiving, by the vehicle lifecycle computer program, vehicle attributes from the telematics unit;
requesting, by the vehicle lifecycle computer program, vehicle condition data from an on-board vehicle management computer program;
receiving, by vehicle lifecycle computer program, the vehicle condition data from the on-board vehicle management computer program;
receiving, by the vehicle lifecycle computer program, a request to terminate the vehicle lifecycle event; and
disabling, by the vehicle lifecycle computer program, the telematics unit.

2. The method of claim 1, wherein the vehicle attributes comprise one or more of a vehicle location, a vehicle odometer reading, and a fault code.

3. The method of claim 1, wherein the vehicle condition data comprise vehicle image data and/or sensed vehicle data.

4. The method of claim 3, wherein the vehicle image data comprises a plurality of images of the vehicle captured by vehicle image capture devices that indicate a current condition of the vehicle.

5. The method of claim 3, wherein the sensed vehicle data comprise identifiers associated with installed equipment on the vehicle.

6. The method of claim 5, wherein the installed equipment comprises vehicle electronics and vehicle body parts.

7. The method of claim 5, wherein the identifiers are associated with radio frequency tags, Bluetooth Low Energy tags, and/or Quick Response codes.

8. The method of claim 1, further comprising:
assessing, by the vehicle lifecycle computer program, a current vehicle condition based on the vehicle attributes by identifying differences between the vehicle condition data and stored vehicle condition data.

9. The method of claim 8, wherein the stored vehicle condition data was received at a prior vehicle lifecycle event.

10. The method of claim 8, further comprising:
assessing, by the vehicle lifecycle computer program, a cost for the identified differences.

11. An electronic device, comprising:
a computer processor; and
a memory storing a vehicle lifecycle computer program;
wherein when executed by the computer processor, the vehicle lifecycle computer program causes the computer processor to:
receive vehicle attributes from a telematics unit in a vehicle;
receive vehicle condition data from an on-board vehicle management computer program in the vehicle;
retrieve stored vehicle condition data for the vehicle;
identifying differences between the vehicle condition data and the stored vehicle condition data;
determining that the differences are not acceptable differences;
assessing a cost associated with the differences; and
communicating the differences and the cost to a vehicle owner.

12. The electronic device of claim 11, wherein the vehicle attributes comprise one or more of a vehicle location, a vehicle odometer reading, and a fault code.

13. The electronic device of claim 11, wherein the vehicle condition data comprise vehicle image data and/or sensed vehicle data.

14. The electronic device of claim 13, wherein the vehicle image data comprises a plurality of images of the vehicle captured by vehicle image capture devices that indicate a current condition of the vehicle.

15. The electronic device of claim 13, wherein the sensed vehicle data comprise identifiers associated with installed equipment on the vehicle.

16. The electronic device of claim 15, wherein the installed equipment comprises vehicle electronics and vehicle body parts.

17. The electronic device of claim 15, wherein the identifiers are associated with radio frequency tags, Bluetooth Low Energy tags, and/or Quick Response codes.

18. A system, comprising:
a vehicle lifecycle server comprising a vehicle lifecycle server computer processor and executing a vehicle lifecycle computer program; and
a vehicle comprising:
a vehicle computer processor executing an onboard vehicle management computer program;
a telematics unit;
a plurality of image capture devices; and
a sensor that senses a presence or absence of vehicle equipment; wherein:
the telematics unit retrieves vehicle attributes from vehicle systems;
the vehicle lifecycle computer program receives the vehicle attributes from the telematics unit;
the onboard vehicle management computer program receives vehicle condition data from the sensor;
the vehicle lifecycle computer program receives the vehicle condition data from the onboard vehicle management computer program;
the vehicle lifecycle computer program retrieves stored vehicle condition data for the vehicle;
the vehicle lifecycle computer program identifies differences between the vehicle condition data and the stored vehicle condition data;
the vehicle lifecycle computer program determines that the differences are not acceptable differences;
the vehicle lifecycle computer program assesses a cost associated with the differences; and
the vehicle lifecycle computer program communicates the differences and the associated cost to a vehicle owner.

19. The system of claim 18, wherein the vehicle attributes comprise one or more of a vehicle location, a vehicle odometer reading, and a fault code.

20. The system of claim 18, wherein the vehicle condition data comprise vehicle image data and/or sensed vehicle data, wherein the vehicle image data comprises a plurality of images of the vehicle captured by vehicle image capture devices that indicate a current condition of the vehicle and the sensed vehicle data comprise identifiers associated with installed equipment on the vehicle, wherein the identifiers are associated with radio frequency tags, Bluetooth Low Energy tags, and/or Quick Response codes.
